(19) United States
(12) Patent Application Publication
(10) Pub. No.: US 2025/0300436 A1
(43) Pub. Date: Sep. 25, 2025

(54) POWER BUSBAR DEVICE AND POWER SUPPLY DEVICE

(71) Applicant: CHROMA ATE INC., Taoyuan City (TW)

(72) Inventors: Chih-Yuan Chang, Taoyuan City (TW); Chong-Lin Liu, Taoyuan City (TW); Wen-Chih Chen, Taoyuan City (TW)

(73) Assignee: CHROMA ATE INC., Taoyuan City (TW)

(21) Appl. No.: 19/050,989

(22) Filed: Feb. 11, 2025

(30) Foreign Application Priority Data
Mar. 21, 2024 (TW) 113110613

(51) Int. Cl. H02B 1/20

(52) U.S. Cl. CPC H02B 1/20

(57) ABSTRACT

A power busbar device includes two output contacts, a plurality of insulation layers, a plurality of trace layers, a plurality of power supply contact groups, and a plurality of switching contact groups. The trace layers and the insulation layers are arranged in an interleaved stack. Each of the switching contact groups includes a first switching contact, a second switching contact, and a switch. The first switching contact, the second switching contact, and the power supply contact groups extend through the insulation layers and the trace layers. The switch enables connection or disconnection between the first switching contact and the second switching contact based on a switching state thereof. Each of the trace layers distributes traces connected to the output contacts, the switching contact groups and the power supply contact groups, to connect the power supply contact groups in series or in parallel based on the switching state of the switch.

### CROSS-REFERENCE TO RELATED APPLICATION

This non-provisional application claims priority under 35 U.S.C. § 119(a) to patent application Ser. No. 11/311,0613 filed in Taiwan, R.O.C. on Mar. 21, 2024, the entire contents of which are hereby incorporated by reference.

### BACKGROUND

### Technical Field

The present invention relates to the field of power supplies, and in particular, to a power busbar device and a power supply device.

### Related Art

A direct current (DC) power supply generates a high-voltage output by connecting internal power modules thereof in series, or generates a high-current output by connecting the internal power modules thereof in parallel. However, the connection mode of the power modules inside the direct current power supply is fixed as series connection or parallel connection when leaving the factory. In other words, a single direct current power supply can only provide one output mode (for example, a high-voltage output or a high-current output) and cannot provide two output modes for users to choose at the same time, resulting in the inability to meet different usage requirements of users with only a single direct current power supply.

### SUMMARY

In view of the above, the present invention provides a power busbar device and a power supply device. A power busbar device includes two output contacts, a plurality of insulation layers, a plurality of trace layers, a plurality of power supply contact groups, and a plurality of switching contact groups. The trace layers and the insulation layers are arranged in an interleaved stack. The power supply contact groups extend through the insulation layers and the trace layers. Each power supply contact group is connected to a power module. Each power supply contact group includes a first power supply contact and a second power supply contact. Each of the switching contact groups includes a first switching contact, a second switching contact, and a switch. The first switching contact and the second switching contact extend through the insulation layers and the trace layers. The switch is connected to the first switching contact and the second switching contact, and the switch is configured to enable connection or disconnection between the first switching contact and the second switching contact based on a switching state thereof. A plurality of traces connected to the two output contacts, each of the switching contact groups, and each of the power supply contact groups are distributed on each of the trace layers, to connect the power supply contact groups in series or in parallel based on the switching state of the switch. The two output contacts are configured to output power generated after the power modules are connected in series when the power supply contact groups are connected in series, and output power generated after the power modules are connected in parallel when the power supply contact groups are connected in parallel.

The power supply device includes a plurality of power modules and a power busbar device. The power busbar device includes two output contacts, a plurality of insulation layers, a plurality of trace layers, a plurality of power supply contact groups, and a plurality of switching contact groups. The trace layers and the insulation layers are arranged in an interleaved stack. The power supply contact groups extend through the insulation layers and the trace layers, and are connected to the power modules. Each power supply contact group includes a first power supply contact and a second power supply contact. Each of the switching contact groups includes a first switching contact, a second switching contact, and a switch. The first switching contact and the second switching contact extend through the insulation layers and the trace layers. The switch is connected to the first switching contact and the second switching contact, and the switch is configured to enable connection or disconnection between the first switching contact and the second switching contact based on a switching state thereof. A plurality of traces connected to the two output contacts, each of the switching contact groups, and each of the power supply contact groups are distributed on each of the trace layers, to connect the power supply contact groups in series or in parallel based on the switching state of the switch. The two output contacts are configured to output power generated after the power modules are connected in series when the power supply contact groups are connected in series, and output power generated after the power modules are connected in parallel when the power supply contact groups are connected in parallel.

Based on the above, according to some embodiments, the present invention can simultaneously provide two output modes (specifically, one output mode is the power generated after the power modules are connected in series, and the other output mode is the power generated after the power modules are connected in parallel) for a user to choose, so that a single device can meet the different usage requirements of the user.

### BRIEF DESCRIPTION OF THE DRAWINGS

FIG. 1 is a schematic front view of a power supply device according to a first embodiment of the present invention;

FIG. 2 is a schematic side view of a power busbar device according to a first embodiment of the present invention;

FIG. 3 is a schematic diagram of a first trace layer according to a first embodiment of the present invention;

FIG. 4 is a schematic diagram of a second trace layer according to a first embodiment of the present invention;

FIG. 5 is a schematic diagram of a third trace layer according to a first embodiment of the present invention;

FIG. 6 is a schematic diagram of an equivalent circuit of a power supply device according to a first embodiment of the present invention;

FIG. 7 is a schematic diagram of an equivalent circuit when power modules of a power supply device according to a first embodiment of the present invention are connected in series;

FIG. 8 is a schematic diagram of an equivalent circuit when power modules of a power supply device according to a first embodiment of the present invention are connected in parallel;

FIG. 9 is a schematic front view of a power supply device according to a second embodiment of the present invention;

FIG. 10 is a schematic diagram of a first trace layer according to a second embodiment of the present invention;

FIG. 11 is a schematic diagram of a second trace layer according to a second embodiment of the present invention;

FIG. 12 is a schematic diagram of a third trace layer according to a second embodiment of the present invention;

FIG. 13 is a schematic diagram of an equivalent circuit of a power supply device according to a second embodiment of the present invention;

FIG. 14 is a schematic diagram of an equivalent circuit when power modules of a power supply device according to a second embodiment of the present invention are connected in series; and

FIG. 15 is a schematic diagram of an equivalent circuit when power modules of a power supply device according to a second embodiment of the present invention are connected in parallel.

### DETAILED DESCRIPTION

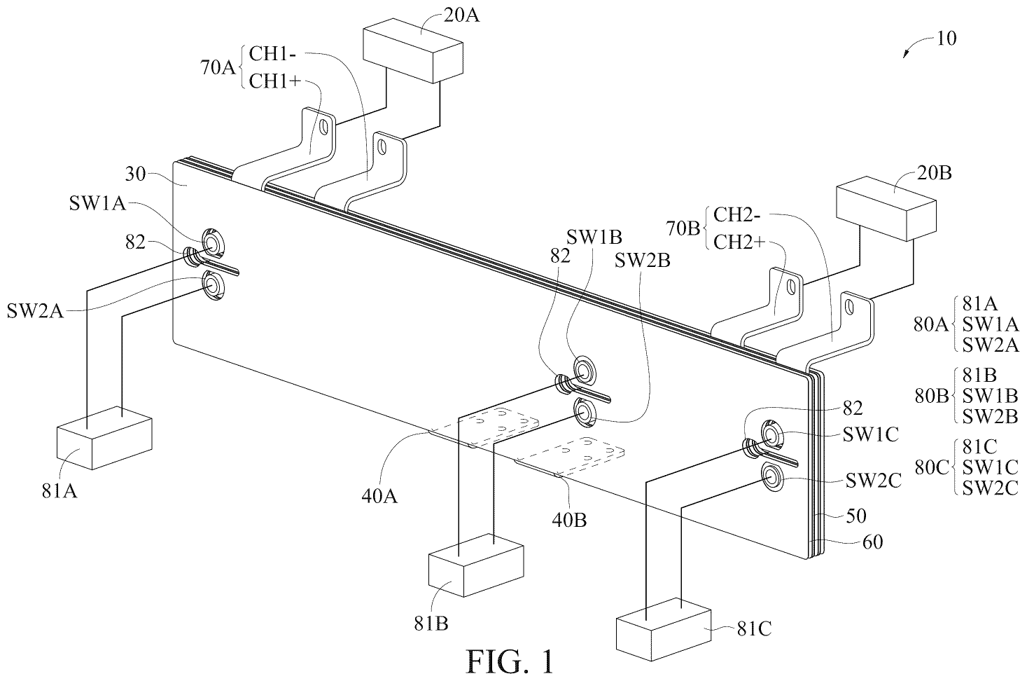

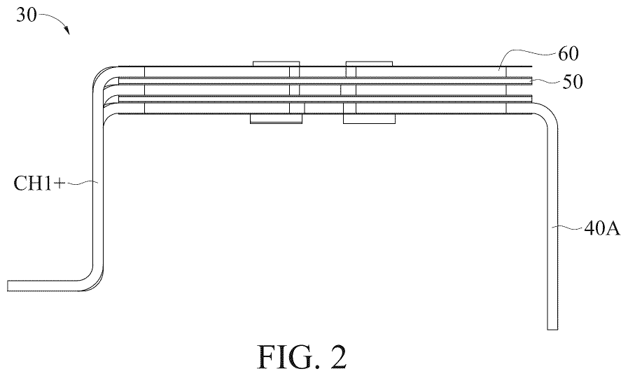

Refer to FIG. 1 and FIG. 2. FIG. 1 is a schematic front view of a power supply device 10 according to a first embodiment of the present invention. FIG. 2 is a schematic side view of a power busbar device 30 according to a first embodiment of the present invention. The power supply device 10 includes a plurality of power modules and the power busbar device 30. The power busbar device 30 includes two output contacts (that is, a first output contact 40A and a second output contact 40B), a plurality of insulation layers 50, a plurality of trace layers 60, a plurality of power supply contact groups, and a plurality of switching contact groups. FIG. 1 shows two power modules (that is, a first power module 20A and a second power module 20B), two power supply contact groups (that is, a first power supply contact group 70A and a second power supply contact group 70B), and three switching contact groups (that is, a first switching contact group 80A, a second switching contact group 80B, and a third switching contact group 80C), but the present invention is not limited thereto. A quantity of power modules, a quantity of power supply contact groups, and a quantity of switching contact groups may be adjusted based on user needs. The first output contact 40A and the second output contact 40B are for connection to an external load device to supply power to the external load device. In some embodiments, the power module may be a direct current (DC) power module.

The trace layers 60 and the insulation layers 50 are arranged in an interleaved stack, so that different trace layers 60 can be isolated from each other and do not interfere with cach other. FIG. 2 shows three trace layers 60 and two insulation layers 50, but the present invention is not limited thereto. A quantity of trace layers and a quantity of insulation layers may be adjusted based on user needs.

The first power supply contact group 70A and the second power supply contact group 70B extend through the insulation layers 50 and the trace layers 60, and are respectively connected to the first power module 20A and the second power module 20B. Since the first power supply contact group 70A and the second power supply contact group 70B have the same composition and function, for brevity, only the first power supply contact group 70A is used as an example for description herein. The first power supply contact group 70A includes a first power supply contact CH1+ and a second power supply contact CH1−, and two output terminals of the first power module 20A are respectively connected to the first power supply contact CH1+ and the second power supply contact CH1−.

Next, the first switching contact group 80A, the second switching contact group 80B, and the third switching contact group 80C are further described. Since the first switching contact group 80A, the second switching contact group 80B, and the third switching contact group 80C have the same composition and function, for brevity, only the first switching contact group 80A is used as an example for description herein. The first switching contact group 80A includes a first switching contact SW1A, a second switching contact SW2A, and a switch 81A. The first switching contact SW1A and the second switching contact SW2A extend through the insulation layers 50 and the trace layers 60. The switch 81A is configured to connect the first switching contact SW1A and the second switching contact SW2A, and the switch 81A is configured to enable connection or disconnection between the first switching contact SW1A and the second switching contact SW2A based on a switching state thereof.

In some embodiments, the switch 81A of the first switching contact group 80A may be implemented by an electronic switch, for example, a relay. In some embodiments, the first switching contact group 80A further includes an isolation groove 82 extending through the insulation layers 50 and the trace layers 60. The isolation groove 82 is located between the corresponding first switching contact SW1A and the corresponding second switching contact SW2A. The isolation groove 82 accommodates an isolation member (for example, a plastic sheet) of the corresponding switching switch 81A, so that when the switching switch 81A enables the disconnection between the first switching contact SW1A and the second switching contact SW2A, the first switching contact SW1A and the second switching contact SW2A are isolated from each other and do not interfere with each other.

A plurality of traces are distributed on each trace layer 60. The traces of the trace layers 60 are connected to two output contacts (that is, the first output contact 40A and the second output contact 40B), the power supply contact groups (for example, the first power supply contact group 70A and the second power supply contact group 70B), and the switching contact groups (for example, the first switching contact group 80A, the second switching contact group 80B, and the third switching contact group 80C), so as to connect the power supply contact groups in series or in parallel based on the switching state of the switch of each switching contact group. The two output contacts are configured to output power generated after the power modules (for example, the first power module 20A and the second power module 20B) are connected in series when the power supply contact groups are connected in series, and output power generated after the power modules are connected in parallel when the power supply contact groups are connected in parallel. In this way, the power supply device 10 can simultaneously provide two output modes (specifically, one output mode is the power generated after the power modules are connected in series to provide a high-voltage output such as 2000 volts (V), and the other output mode is the power generated after the power modules are connected in parallel to provide a high-current output such as 180 amperes (A)) for a user to select (for example, the switching state of each switch of each switching contact group is controlled to select the output mode), so that a single device can meet the different usage requirements of the user.

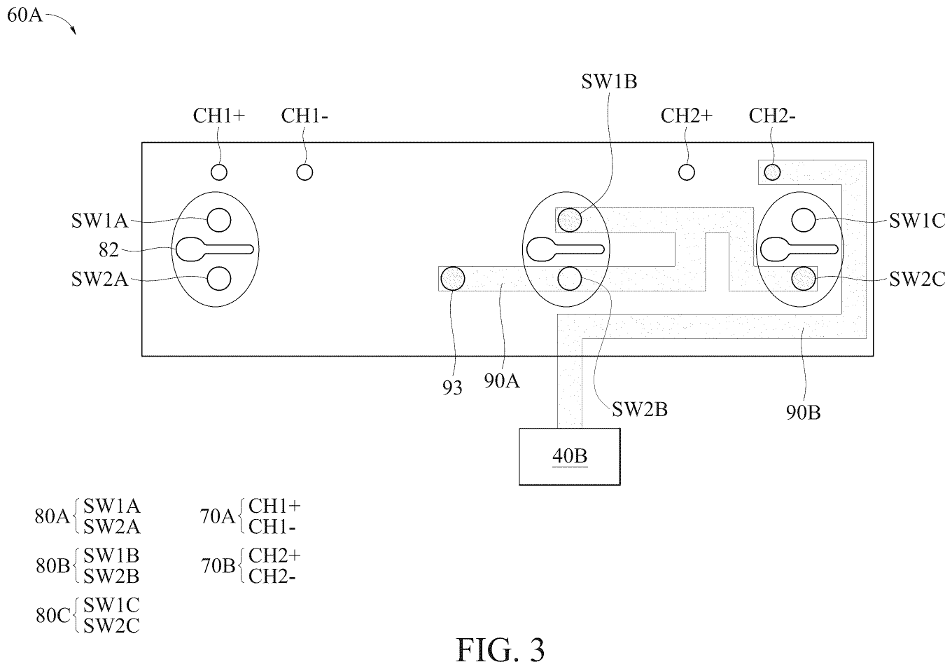

In some embodiments, the power busbar device 30 of the power supply device 10 further includes a relay contact 93 (as shown in FIG. 3 to FIG. 5) extending through the insulation layers 50 and the trace layers 60, so that the traces of the trace layers 60 connect the relay contact 93 to other components.

The trace connection mode of the first embodiment of the power supply device 10 is described below by using the trace layers 60 including a first trace layer 60A, a second trace layer 60B, and a third trace layer 60C. In FIG. 3 to FIG. 5, solid dots are used to indicate that components are connected by traces, and hollow dots are used to indicate that components are not connected by traces.

Refer to FIG. 3. FIG. 3 is a schematic diagram of a first trace layer 60A according to a first embodiment of the present invention. The first trace layer 60A includes a first trace 90A and a second trace 90B. The first trace 90A connects a first switching contact SW1B of a second switching contact group 80B to a second switching contact SW2C of a third switching contact group 80C and a relay contact 93. The second trace 90B connects a second power supply contact CH2− of a second power supply contact group 70B to a second output contact 40B.

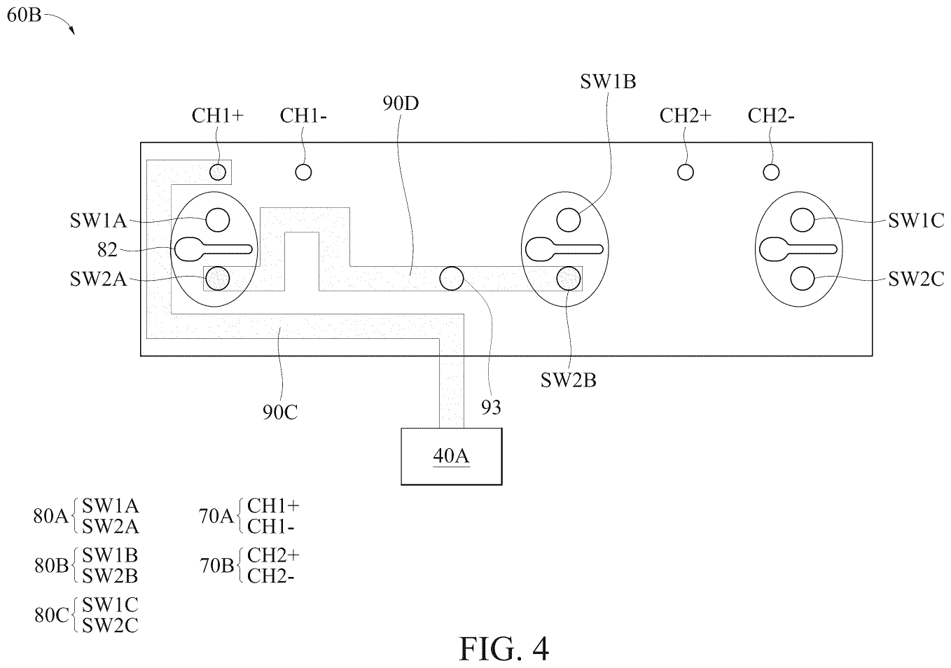

Refer to FIG. 4. FIG. 4 is a schematic diagram of a second trace layer 60B according to a first embodiment of the present invention. The second trace layer 60B includes a third trace 90C and a fourth trace 90D. The third trace 90C connects a first power supply contact CH1+ of a first power supply contact group 70A to a first output contact 40A. The fourth trace 90D connects a second switching contact SW2A of a first switching contact group 80A to a second switching contact SW2B of a second switching contact group 80B.

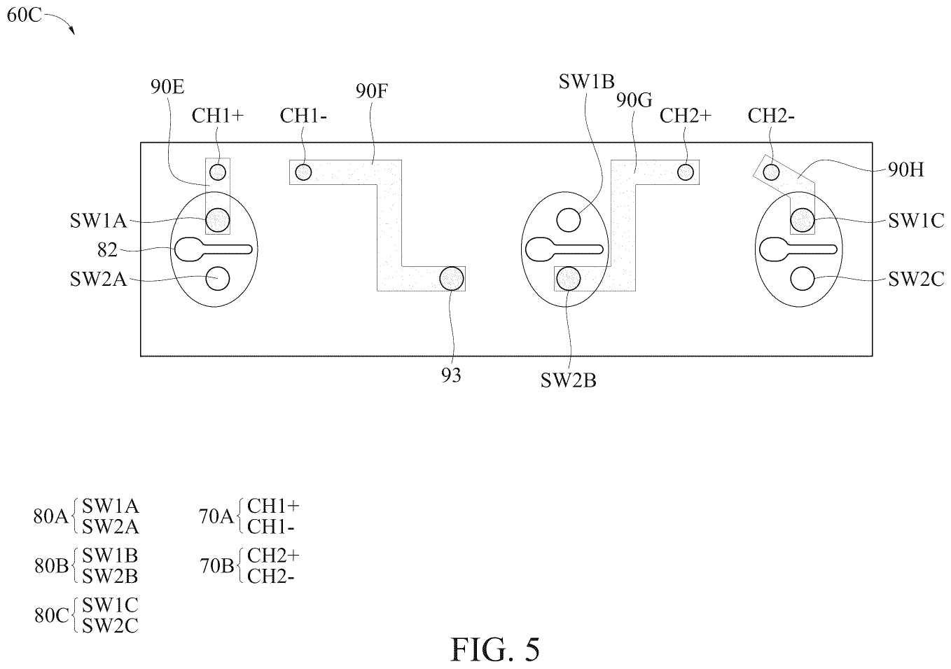

Refer to FIG. 5. FIG. 5 is a schematic diagram of a third trace layer 60C according to a first embodiment of the present invention. The third trace layer 60C includes a fifth trace 90E, a sixth trace 90F, a seventh trace 90G, and an eighth trace 90H. The fifth trace 90E connects a first power supply contact CH1+ of a first power supply contact group 70A to a first switching contact SW1A of a first switching contact group 80A. The sixth trace 90F connects a second power supply contact CH1− of the first power supply contact group 70A to a relay contact 93. The seventh trace 90G connects a second switching contact SW2B of a second switching contact group 80B to a first power supply contact CH2+ of a second power supply contact group 70B. The eighth trace 90H connects a second power supply contact CH2− of the second power supply contact group 70B to a first switching contact SW1C of a third switching contact group 80C.

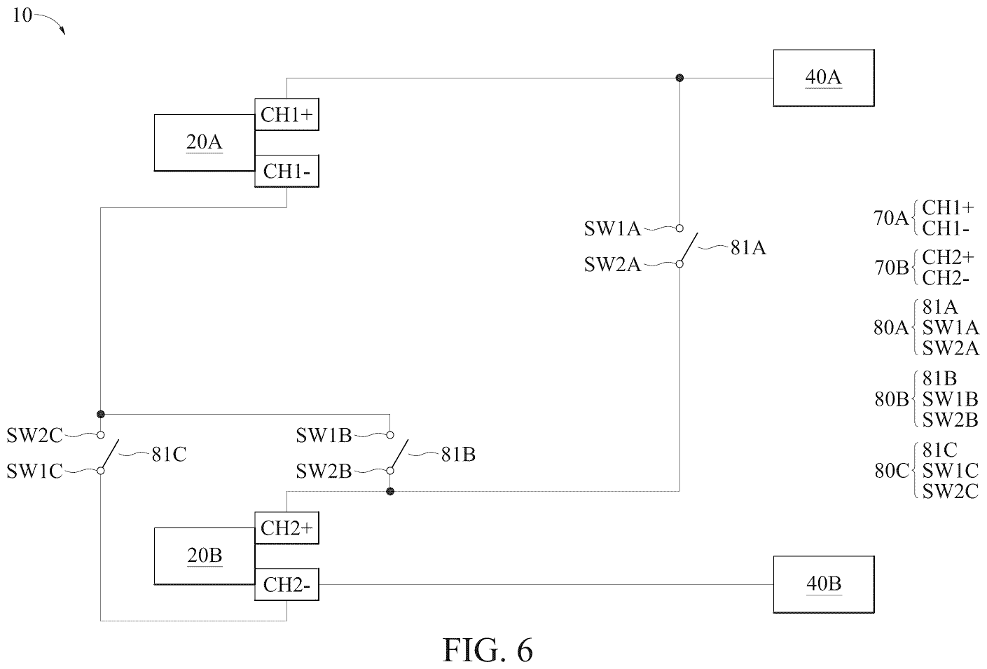

Refer to FIG. 6. FIG. 6 is a schematic diagram of an equivalent circuit of a power supply device 10 according to a first embodiment of the present invention. The power supply device 10 causes, through the first trace 90A to the eighth trace 90H of the trace layers 60 as shown in FIG. 3 to FIG. 5, a first power module 20A and a second power module 20B to form a series-parallel circuit. The power supply device 10 switches the power modules into a series circuit or a parallel circuit by controlling a switching state of each switch of each switching contact group. For example, the first power module 20A is connected to a first power supply contact CH1+ and a second power supply contact CH1+ of a first power supply contact group 70A, and the second power module 20B is connected to a first power supply contact CH2+ and a second power supply contact CH2− of a second power supply contact group 70B. A first output contact 40A is connected to the first power supply contact CH1+ of the first power supply contact group 70A, and a second output contact 40B is connected to the second power supply contact CH2− of the second power supply contact group 70B. A first switching contact group 80A is connected between the first power supply contact CH1+ of the first power supply contact group 70A and the first power supply contact CH2+ of the second power supply contact group 70B. A second switching contact group 80B is connected between the second power supply contact point CH1− of the first power supply contact group 70A and the first power supply contact CH2+ of the second power supply contact group 70B. A third switching contact group 80C is connected between the second power supply contact CH1− of the first power supply contact group 70A and the second power supply contact CH2− of the second power supply contact group 70B.

Specifically, a first switching contact SW1A of the first switching contact group 80A, the first output contact 40A, and the first power supply contact CH1+ of the first power supply contact group 70A are connected together. A second switching contact SW2A of the first switching contact group 80A, a second switching contact SW2B of the second switching contact group 80B, and the first power supply contact CH2+ of the second power supply contact group 70B are connected together. A first switching contact SW1B of the second switching contact group 80B, a second switching contact SW2C of the third switching contact group 80C, and the second power supply contact CH1− of the first power supply contact group 70A are connected together. A first switching contact SW1C of the third switching contact group 80C, the second power supply contact CH2− of the second power supply contact group 70B, and the second output contact 40B are connected together.

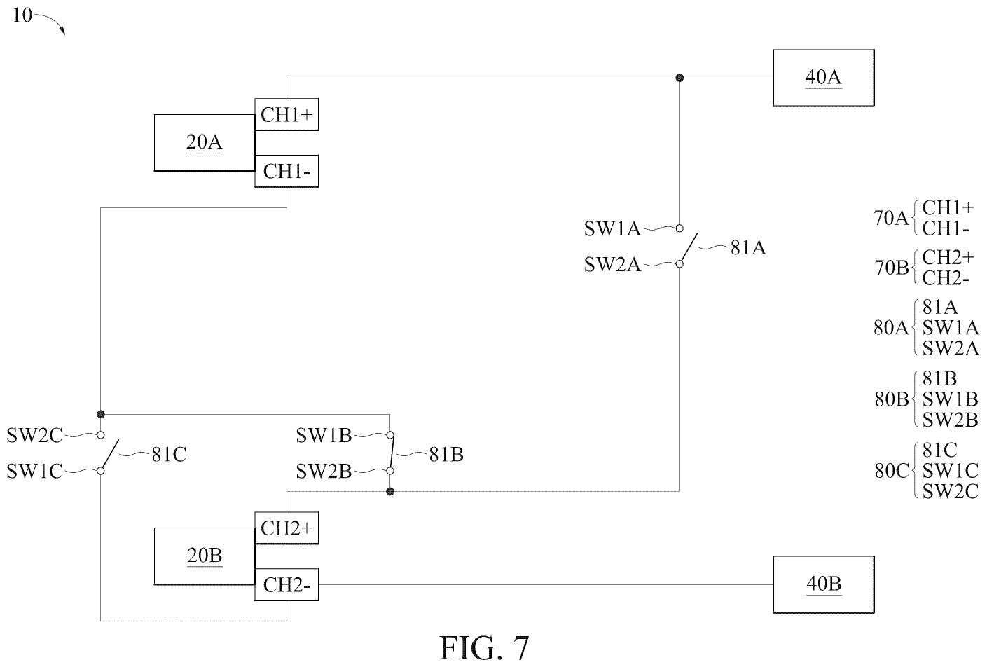

Refer to FIG. 7. FIG. 7 is a schematic diagram of an equivalent circuit when power modules of a power supply device 10 according to a first embodiment of the present invention are connected in series. When a user wants to choose to use a high-voltage output, the user may input an instruction to the power supply device 10 through an electronic device, and the power supply device 10 controls, in response to the instruction, switching states of a switch 81A and a switch 81C to be an off state (i.e., cut off state), and controls a switching state of the switch 81B to be an on state (i.e., conductive state), so that the first power module 20A and the second power module 20B are switched to a series circuit to generate high-voltage power.

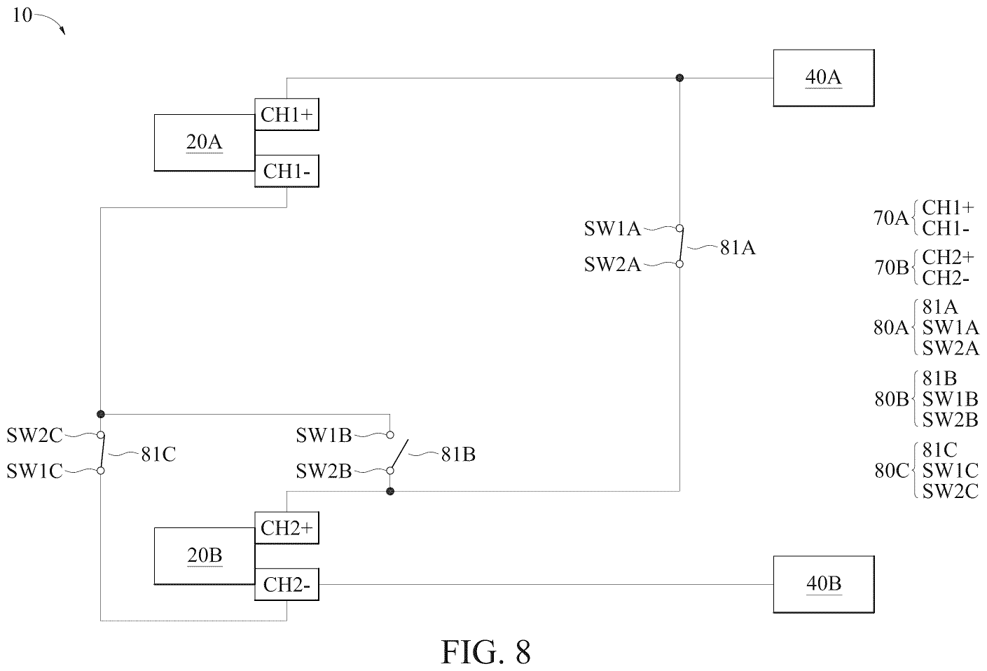

Refer to FIG. 8. FIG. 8 is a schematic diagram of an equivalent circuit when power modules of a power supply device 10 according to a first embodiment of the present invention are connected in parallel. When a user wants to choose to use a high-current output, the user may input an instruction to the power supply device 10 through an electronic device, and the power supply device 10 controls, in response to the instruction, switching states of a switch 81A and a switch 81C to be an on state (i.e., conductive state), and controls aa switching state of a switch 81B to be an off state (i.e., cut off state), so that the first power module 20A and the second power module 20B are switched to a parallel circuit to generate high-current power.

It should be noted that the quantity and a trace manner of the trace layers 60 of the first embodiment shown in FIG. 3 to FIG. 5 are merely examples, and the present invention is not limited thereto.

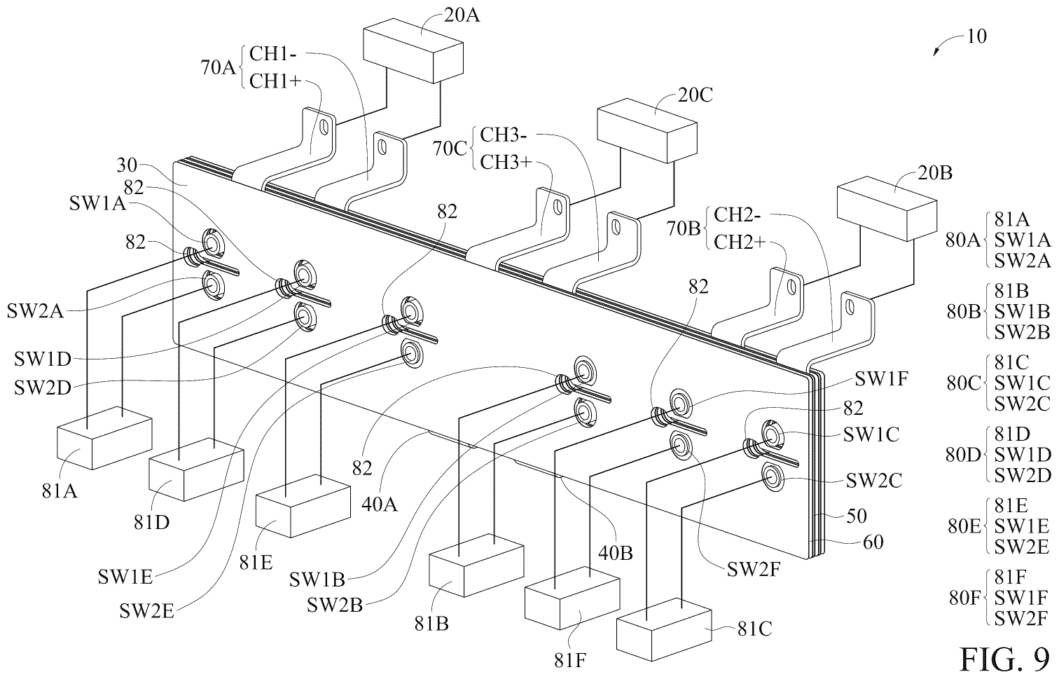

Refer to FIG. 9. FIG. 9 is a schematic front view of a power supply device 10 according to a second embodiment of the present invention. The power supply device 10 of the second embodiment is substantially the same as that of the first embodiment, and a difference lies in a quantity of power modules, a quantity of power supply contact groups, and a quantity of switching contact groups. In the second embodiment, the quantity of power modules is three, for example, a first power module 20A, a second power module 20B, and a third power module 20C. The quantity of power supply contact groups is three, for example, a first power supply contact group 70A, a second power supply contact group 70B, and a third power supply contact group 70C. The quantity of switching contact groups is six, for example, a first switching contact group 80A, a second switching contact group 80B, a third switching contact group 80C, a fourth switching contact group 80D, a fifth switching contact group 80E, and a sixth switching contact group 80F.

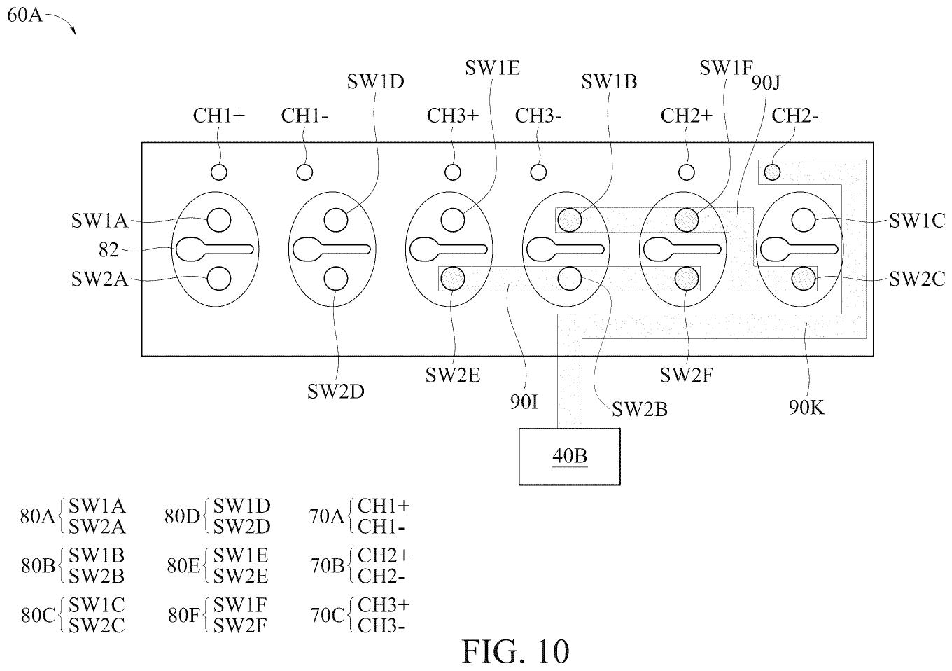

The trace connection mode of the second embodiment of the power supply device 10 is described below by using the trace layers 60 including a first trace layer 60A, a second trace layer 60B, and a third trace layer 60C. In FIG. 10 to FIG. 12, solid dots are used to indicate that components are connected by traces, and hollow dots are used to indicate that components are not connected by traces.

Refer to FIG. 10. FIG. 10 is a schematic diagram of a first trace layer 60A according to a second embodiment of the present invention. The first trace layer 60A includes a ninth trace 90I, a tenth trace 90J, and an eleventh trace 90K. The ninth trace 90I connects a second switching contact SW2E of a fifth switching contact group 80E to a second switching contact SW2F of a sixth switching contact group 80F. The tenth trace 90J connects a first switching contact SW1B of a second switching contact group 80B to a first switching contact SW1F of the sixth switching contact group 80F and a second switching contact SW2C of a third switching contact group 80C. The eleventh trace 90K connects a second power supply contact CH2− of a second power supply contact group 70B to a second output contact 40B.

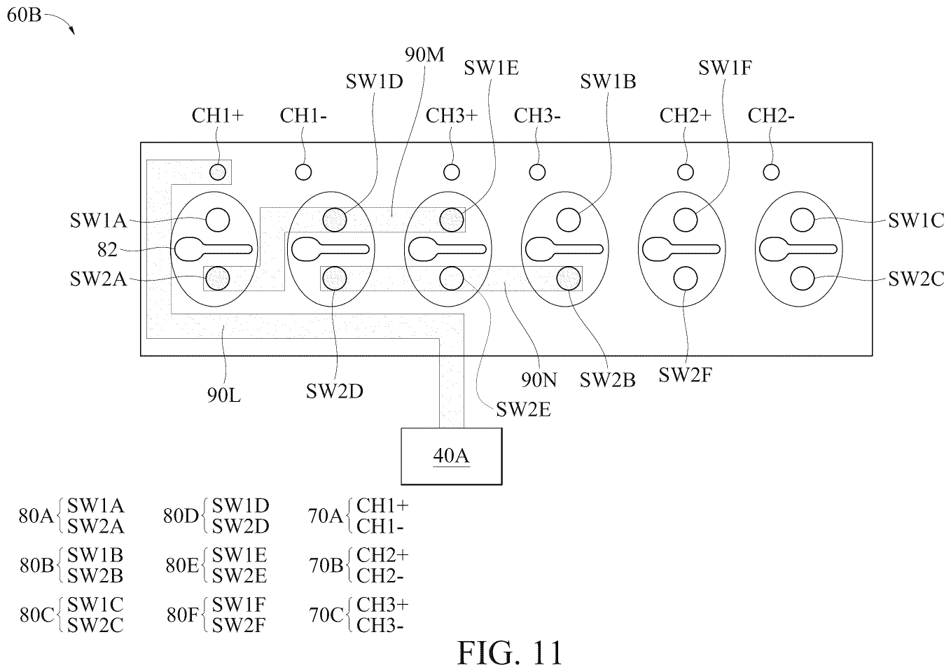

Refer to FIG. 11. FIG. 11 is a schematic diagram of a second trace layer 60B according to a second embodiment of the present invention. The second trace layer 60B includes a twelfth trace 90L, a thirteenth trace 90M, and a fourteenth trace 90N. The twelfth trace 90L connects a first power supply contact CH1+ of a first power supply contact group 70A to a first output contact 40A. The thirteenth trace 90M connects a second switching contact SW2A of a first switching contact group 80A to a first switching contact SW1D of a fourth switching contact group 80D and a first switching contact SW1E of a fifth switching contact group 80E. The fourteenth trace 90N connects a second switching contact SW2D of the fourth switching contact group 80D to a second switching contact SW2B of a second switching contact group 80B.

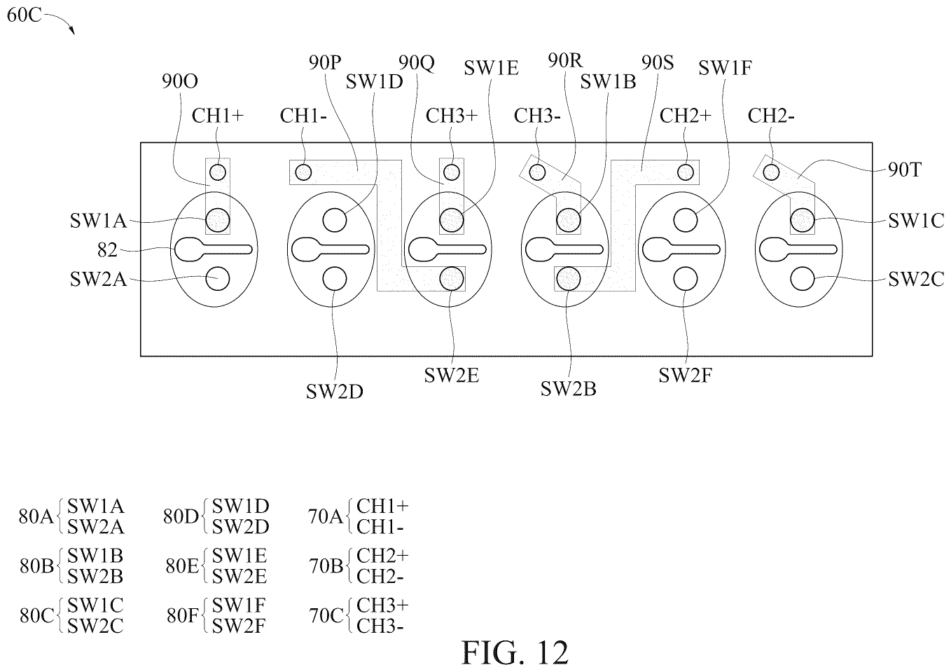

Refer to FIG. 12. FIG. 12 is a schematic diagram of a third trace layer 60C according to a second embodiment of the present invention. The third trace layer 60C includes a fifteenth trace 900, a sixteenth trace 90P, a seventeenth trace 90Q, an eighteenth trace 90R, a nineteenth trace 90S, and a twentieth trace 90T. The fifteenth trace 90O connects a first power supply contact CH1+ of a first power supply contact group 70A to a first switching contact SW1A of a first switching contact group 80A. The sixteenth trace 90P connects a second power supply contact CH1− of the first power supply contact group 70A to a second switching contact SW2E of a fifth switching contact group 80E. The seventeenth trace 90Q connects a first power supply contact CH3+ of a third power supply contact group 70C to a first switching contact SW1E of the fifth switching contact group 80E. The eighteenth trace 90R connects a second power supply contact CH3− of the third power supply contact group 70C to a first switching contact SW1B of a second switching contact group 80B. The nineteenth trace 90S connects a second switching contact SW2B of the second switching contact group 80B to a first power supply contact CH2+ of a second power supply contact group 70B. The twentieth trace 90T connects a second power supply contact CH2− of the second power supply contact group 70B to a first switching contact SW1C of a third switching contact group 80C.

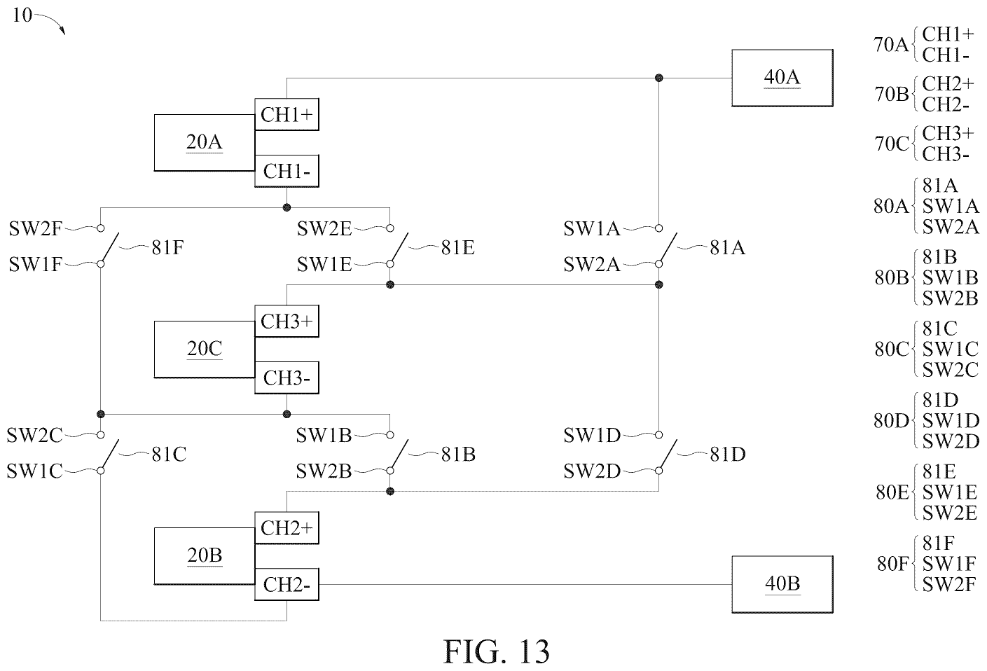

Refer to FIG. 13. FIG. 13 is a schematic diagram of an equivalent circuit of a power supply device 10 according to a second embodiment of the present invention. The power supply device 10 causes, through the ninth trace 90I to the twentieth trace 90T of the trace layers 60 as shown in FIG. 10 to FIG. 12, a first power module 20A, a second power module 20B, and a third power module 20C to form a series-parallel circuit. The power supply device 10 switches the power modules into a series circuit or a parallel circuit by controlling a switching state of cach switch of each switching contact group. For example, the first power module 20A is connected to a first power supply contact CH1+ and a second power supply contact CH1− of a first power supply contact group 70A, the second power module 20B is connected to a first power supply contact CH2+ and a second power supply contact CH2− of a second power supply contact group 70B, and the third power module 20C is connected to a first power supply contact CH3+ and a second power supply contact CH3− of a third power supply contact group 70C. A first output contact 40A is connected to the first power supply contact CH1+ of the first power supply contact group 70A, and a second output contact 40B is connected to the second power supply contact CH2− of the second power supply contact group 70B. A first switching contact group 80A is connected between the first power supply contact CH1+ of the first power supply contact group 70A and the first power supply contact CH3+ of the third power supply contact group 70C. A second switching contact group 80B is connected between the second power supply contact point CH3− of the third power supply contact group 70C and the first power supply contact CH2+ of the second power supply contact group 70B. A third switching contact group 80C is connected between the second power supply contact CH3− of the third power supply contact group 70C and the second power supply contact CH2− of the second power supply contact group 70B. A fourth switching contact group 80D is connected between the first switching contact group 80A and the first power supply contact CH2+ of the second power supply contact group 70B. A fifth switching contact group 80E is connected between the second power supply contact CH1− of the first power supply contact group 70A and the first power supply contact CH3+ of the third power supply contact group 70C. A sixth switching contact group 80F is connected between the second power supply contact CH1− of the first power supply contact group 70A and the second power supply contact CH3− of the third power supply contact group 70C. The first power supply contact CH3+ of the third power supply contact group 70C is further connected between the first switching contact group 80A and the fourth switching contact group 80D.

Specifically, a first switching contact SW1A of the first switching contact group 80A, the first output contact 40A, and the first power supply contact CH1+ of the first power supply contact group 70A are connected together. A second switching contact SW2A of the first switching contact group 80A, a first switching contact SW1E of the fifth switching contact group 80E, the first power supply contact CH3+ of the third power supply contact group 70C, and a first switching contact SW1D of the fourth switching contact group 80D are connected together. A second switching contact SW2D of the fourth switching contact group 80D, a second switching contact SW2B of the second switching contact group 80B, and the first power supply contact CH2+ of the second power supply contact group 70B are connected together. The second power supply contact CH1− of the first power supply contact group 70A, a second switching contact SW2E of the fifth switching contact group 80E, and a second switching contact SW2F of the sixth switching contact group 80F are connected together. The second power supply contact CH3− of the third power supply contact group 70C, a first switching contact SW1B of the second switching contact group 80B, a second switching contact SW2C of the third switching contact group 80C, and a first switching contact SW1F of the sixth switching contact group 80F are connected together. A first switching contact SW1C of the third switching contact group 80C, the second power supply contact CH2− of the second power supply contact group 70B, and the second output contact 40B are connected together.

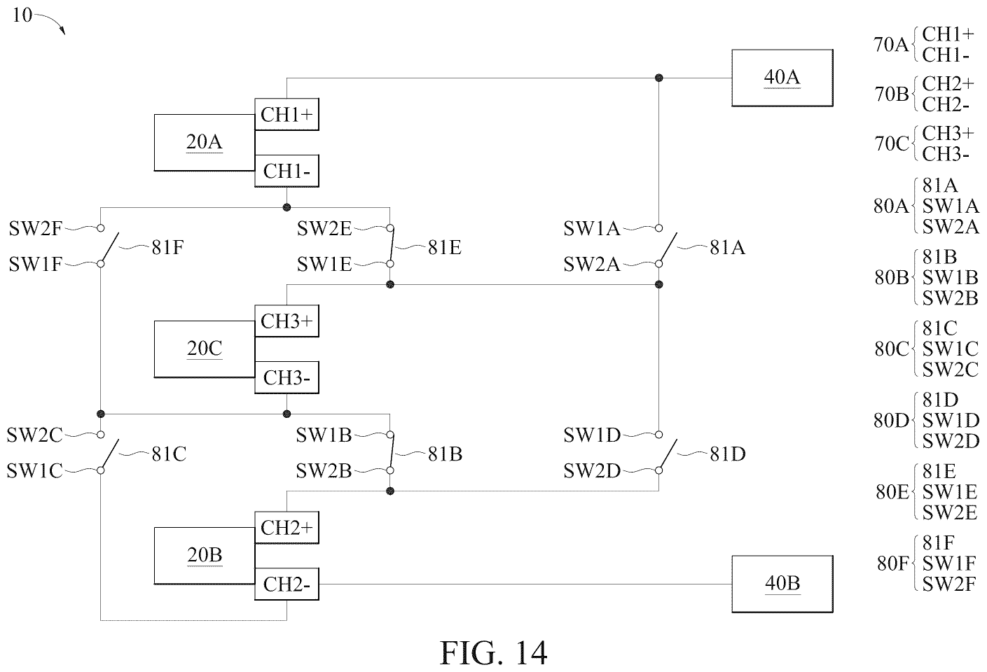

Refer to FIG. 14. FIG. 14 is a schematic diagram of an equivalent circuit when power modules of a power supply device 10 according to a second embodiment of the present invention are connected in series. When a user wants to choose to use a high-voltage output, the user may input an instruction to the power supply device 10 through an electronic device, and the power supply device 10 controls, in response to the instruction, switching states of a switch 81A, a switch 81C, a switch 81D, and a switch 81F to be an off state (i.e., cut off state), and controls switching states of a switch 81B and a switch 81E to be an on state (i.e., conductive state), so that a first power module 20A, a second power module 20B, and a third power module 20C are switched to a series circuit to generate high-voltage power.

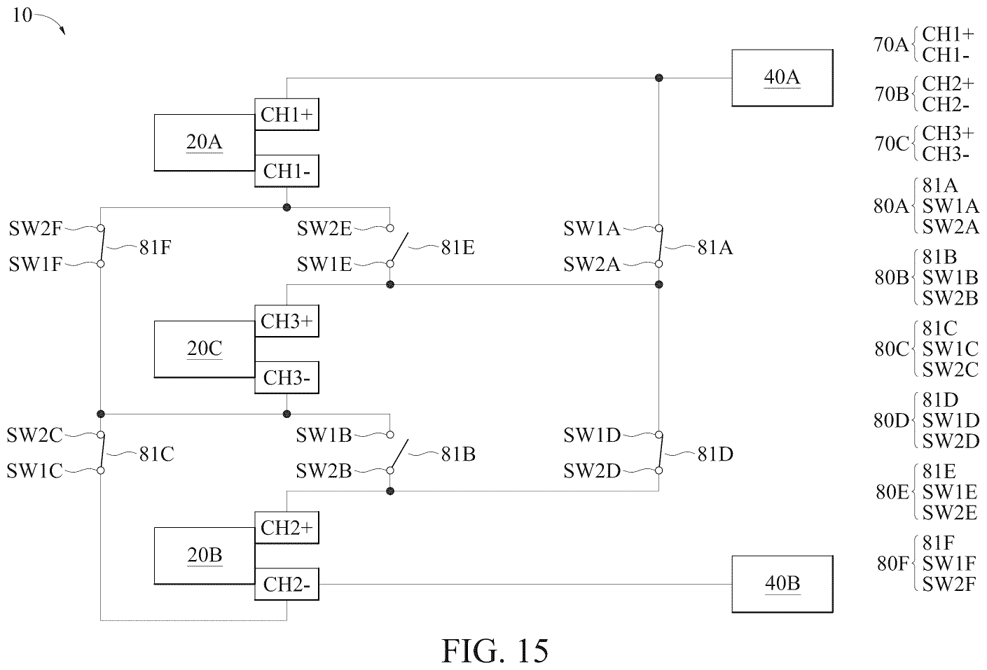

Refer to FIG. 15. FIG. 15 is a schematic diagram of an equivalent circuit when power modules of a power supply device 10 according to a second embodiment of the present invention are connected in parallel. When a user wants to choose to use a high-current output, the user may input an instruction to the power supply device 10 through an electronic device, and the power supply device 10 controls, in response to the instruction, switching states of a switch 81A, a switch 81C, a switch 81D, and a switch 81F of a first switching contact group 80A to be an on state (i.e., conductive state), and controls switching states of a switch 81B and a switch 81E to be an off state (i.e., cut off state), so that a first power module 20A, a second power module 20B, and a third power module 20C are switched to a parallel circuit to generate high-current power.

It should be noted that the quantity and a trace manner of the trace layers 60 of the second embodiment shown in FIG. 10 to FIG. 12 are merely examples, and the present invention is not limited thereto.

In some embodiments, traces in a single trace layer 60 are separated from each other. In some embodiments, the traces are formed by laying metal, for example, copper bars. In some embodiments, an insulation layer 50 is made of an insulation material, for example, a glass fiber block. In some embodiments, as shown in FIG. 3, a thickness of the trace layer 60 is greater than a thickness of the insulation layer 50. For example, the thickness of the trace layer 60 is 2 mm, and the thickness of the insulation layer 50 is 1 mm. In some embodiments, surfaces of the trace layer 60 and the insulation layer 50 may be coated with insulation paint to enhance an insulation effect. In some embodiments, a coating thickness of the insulation paint may be between 0.15 mm and 0.25 mm.

Based on the above, according to some embodiments, the present invention can simultaneously provide two output modes (specifically, one output mode is the power generated after the power modules are connected in series, and the other output mode is the power generated after the power modules are connected in parallel) for a user to choose, so that a single device can meet the different usage requirements of the user.

What is claimed is:

1. A power busbar device, comprising:
two output contacts;
a plurality of insulation layers;
a plurality of trace layers, arranged in an interleaved stack with the insulation layers;
a plurality of power supply contact groups, extending through the insulation layers and the trace layers, wherein each of the power supply contact groups is connected to a power module, and each of the power supply contact groups comprises a first power supply contact and a second power supply contact; and
a plurality of switching contact groups, each comprising a first switching contact, a second switching contact, and a switch, wherein the first switching contact and the second switching contact extend through the insulation layers and the trace layers, the switch is configured to connect the first switching contact and the second switching contact, and the switch is configured to enable connection or disconnection between the first switching contact and the second switching contact based on a switching state thereof, wherein
a plurality of traces connected to the two output contacts, each of the switching contact groups, and each of the power supply contact groups are distributed on each of the trace layers, to connect the power supply contact groups in series or in parallel based on the switching state of the switch, and the two output contacts are configured to output power generated after the power modules are connected in series when the power supply contact groups are connected in series, and output power generated after the power modules are connected in parallel when the power supply contact groups are connected in parallel.

2. The power busbar device according to claim 1, wherein a first one of the switching contact groups is connected between the first power supply contact of a first one of the power supply contact groups and the first power supply contact of a second one of the power supply contact groups through the traces of each of the trace layers; a second one of the switching contact groups is connected between the second power supply contact of the first one of the power supply contact groups and the first power supply contact of the second one of the power supply contact groups through the traces of each of the trace layers; and a third one of the switching contact groups is connected between the second power supply contact of the first one of the power supply contact groups and the second power supply contact of the second one of the power supply contact groups through the traces of each of the trace layers.

3. The power busbar device according to claim 2, further comprising a relay contact extending through the insulation layers and the trace layers, wherein the traces of a first one of the trace layers are configured to connect the first switching contact of the second one of the switching contact groups to the second switching contact of the third one of the switching contact groups and the relay contact; the traces of a second one of the trace layers are configured to connect the second switching contact of the first one of the switching contact groups to the second switching contact of the second one of the switching contact groups; and the traces of a third one of the trace layers are configured to connect the first power supply contact of the first one of the power supply contact groups to the first switching contact of the first one of the switching contact groups, connect the second power supply contact of the first one of the power supply contact groups to the relay contact, connect the second switching contact of the second one of the switching contact groups to the first power supply contact of the second one of the power supply contact groups, and connect the second power supply contact of the second one of the power supply contact groups to the first switching contact of the third one of the switching contact groups.

4. The power busbar device according to claim 2, wherein when the disconnection between the first switching contact and the second switching contact of the first one of the switching contact groups is enabled, the connection between the first switching contact and the second switching contact of the second one of the switching contact groups is enabled, and the disconnection between the first switching contact and the second switching contact of the third one of the switching contact groups is enabled, the first one and the second one of the power supply contact groups are connected in series, and the two output contacts output the power generated after the power modules are connected in series.

5. The power busbar device according to claim 2, wherein when the connection between the first switching contact and the second switching contact of the first one of the switching contact groups is enabled, the disconnection between the first switching contact and the second switching contact of the second one of the switching contact groups is enabled, and the connection between the first switching contact and the second switching contact of the third one of the switching contact groups is enabled, the first one and the second one of the power supply contact groups are connected in parallel, and the two output contacts output the power generated after the power modules are connected in parallel.

6. The power busbar device according to claim 2, wherein a fourth one of the switching contact groups is connected between the first one of the switching contact groups and the first power supply contact of the second one of the power supply contact groups through the traces of each of the trace layers; a fifth one of the switching contact groups is connected between the second power supply contact of the first one of the power supply contact groups and the first power supply contact of the third one of the power supply contact groups through the traces of each of the trace layers; a sixth one of the switching contact groups is connected between the second power supply contact of the first one of the power supply contact groups and the second power supply contact of the third one of the power supply contact groups through the traces of each of the trace layer; the first power supply contact of the third one of the power supply contact groups is connected between the first one of the switching contact groups and the fourth one of the switching contact groups; and the second power supply contact of the third one of the power supply contact groups is connected between the second one of the switching contact groups and the third one of the switching contact groups.

7. The power busbar device according to claim 6, wherein the traces of the first one of the trace layers are configured to connect the second switching contact of the fifth one of the switching contact groups to the second switching contact of the sixth one of the switching contact groups, and connect the first switching contact of the second one of the switching contact groups to the first switching contact of the sixth one of the switching contact groups and the second switching contact of the third one of the switching contact groups; the traces of the second one of the trace layers are configured to connect the second switching contact of the first one of the switching contact groups to the first switching contact of the fourth one of the switching contact groups and the first switching contact of the fifth one of the switching contact groups, and connect the second switching contact of the fourth one of the switching contact groups to the second switching contact of the second one of the switching contact groups; the traces of the third one of the trace layers are configured to connect the first power supply contact of the first one of the power supply contact groups to the first switching contact of the first one of the switching contact groups, connect the second power supply contact of the first one of the power supply contact groups to the second switching contact of the fifth one of the switching contact groups, connect the first power supply contact of the third one of the power supply contact groups to the first switching contact of the fifth one of the switching contact groups, connect the second power supply contact of the third one of the power supply contact groups to the first switching contact of the second one of the switching contact groups, connect the second switching contact of the second one of the switching contact groups to the first power supply contact of the second one of the power supply contact groups, and connect the second power supply contact of the second one of the power supply contact groups to the first switching contact of the third one of the switching contact groups.

8. The power busbar device according to claim 6, wherein when the disconnection between the first switching contact and the second switching contact of the first one of the switching contact groups is enabled, the connection between the first switching contact and the second switching contact of the second one of the switching contact groups is enabled, the disconnection between the first switching contact and the second switching contact of the third one of the switching contact groups is enabled, the disconnection between the first switching contact and the second switching contact of the fourth one of the switching contact groups is enabled, the connection between the first switching contact and the second switching contact of the fifth one of the switching contact groups is enabled, and the disconnection between the first switching contact and the second switching contact of the sixth one of the switching contact groups is enabled, the first one, the second one, and the third one of the power supply contact groups are connected in series, and the two output contacts output the power generated after the power modules are connected in series.

9. The power busbar device according to claim 6, wherein when the connection between the first switching contact and the second switching contact of the first one of the switching contact groups is enabled, the disconnection between the first switching contact and the second switching contact of the second one of the switching contact groups is enabled, the connection between the first switching contact and the second switching contact of the third one of the switching contact groups is enabled, the connection between the first switching contact and the second switching contact of the fourth one of the switching contact groups is enabled, the disconnection between the first switching contact and the second switching contact of the fifth one of the switching contact groups is enabled, and the connection between the first switching contact and the second switching contact of the sixth one of the switching contact groups is enabled, the first one, the second one, and the third one of the power supply contact groups are connected in parallel, and the two output contacts output the power generated after the power modules are connected in parallel.

10. The power busbar device according to claim 1, wherein the first power supply contact of the first one of the power supply contact groups is connected to one of the two output contacts through the traces of each of the trace layers, and the second power supply contact of the second one of the power supply contact groups is connected to the other of the two output contacts through the traces of each of the trace layers.

11. A power supply device, comprising:
a plurality of power modules; and
the power busbar device according to claim 1, wherein the power supply contact groups are respectively connected to the power modules.

12. A power supply device, comprising:
a plurality of power modules; and
the power busbar device according to claim 2, wherein the power supply contact groups are respectively connected to the power modules.

13. A power supply device, comprising:
a plurality of power modules; and
the power busbar device according to claim 3, wherein the power supply contact groups are respectively connected to the power modules.

14. A power supply device, comprising:
a plurality of power modules; and
the power busbar device according to claim 4, wherein the power supply contact groups are respectively connected to the power modules.

15. A power supply device, comprising:
a plurality of power modules; and
the power busbar device according to claim 5, wherein the power supply contact groups are respectively connected to the power modules.

16. A power supply device, comprising:
a plurality of power modules; and
the power busbar device according to claim 6, wherein the power supply contact groups are respectively connected to the power modules.

17. A power supply device, comprising:
a plurality of power modules; and
the power busbar device according to claim 7, wherein the power supply contact groups are respectively connected to the power modules.

18. A power supply device, comprising:
a plurality of power modules; and
the power busbar device according to claim 8, wherein the power supply contact groups are respectively connected to the power modules.

19. A power supply device, comprising:
a plurality of power modules; and
the power busbar device according to claim 9, wherein the power supply contact groups are respectively connected to the power modules.

20. A power supply device. comprising:
a plurality of power modules; and
the power busbar device according to claim 10, wherein the power supply contact groups are respectively connected to the power modules.
